(19) United States
(12) Patent Application Publication
(10) Pub. No.: US 2006/0165132 A1
(43) Pub. Date: Jul. 27, 2006

(54) Computer peripheral interface

(75) Inventor: Ya-Ching Chang, Taipei (TW)

Correspondence Address: BACON & THOMAS, PLLC, 625 SLATERS LANE, FOURTH FLOOR, ALEXANDRIA, VA, 22314, US

(73) Assignee: Emin Chou, Hsinchu (TW)

(21) Appl. No.: 10/987,155

(22) Filed: Nov. 15, 2004

(51) Int. Cl. H04J 3/04

(52) U.S. Cl. 370/535

(57) ABSTRACT

Disclosed is a computer peripheral interface comprising a mainframe end unit for connection with a mainframe of the computer and for receiving/transmitting signals from/to the mainframe; and a user end unit for connection with a plurality of peripherals and for receiving/transmitting signals from/to the respective peripherals. The user end unit and mainframe end unit are separately implemented in different individual objects, and connected with each other by means of a connection medium so that the signals are transferred therebetween. The connection medium can be implemented by optical fiber. The user end unit can be integrated in one of the peripherals such as the monitor, while the mainframe end unit can be integrated in the mainframe of the computer.

### BACKGROUND OF THE INVENTION

1. Field of the Invention

The present invention relates to a computer interface, more specifically, to an interface for the connection of computer peripherals.

2. Description of the Prior Art

In addition to monitor or projector, various peripherals such as mouse, keyboard, audio speaker, microphone, camera, USB device, IEEE 1394 device, touch panel, joystick, printer, telephone and power switch are available to extend the functions of the computer. In conventional practice, those peripherals are connected to the mainframe of the computer by means of cables. The length of the cable for connecting the peripheral to the mainframe is usually limited to a certain level. Accordingly, the peripherals are needed to be located in the vicinity of the mainframe, resulting in complication and difficulty in wiring and arranging the peripherals when there are a number of peripherals are connected.

Therefore, there is a need for a solution to overcome the problem stated above. The present invention satisfies such a need.

### SUMMARY OF THE INVENTION

An objective of the present invention is to provide a computer peripheral interface, which allows the connections between the peripherals and the mainframe of the computer to be simplified and concentrated.

According to an aspect of the present invention, a computer peripheral interface comprises a mainframe end unit for connection with a mainframe of the computer and for receiving/transmitting signals from/to the mainframe; and a user end unit for connection with a plurality of peripherals and for receiving/transmitting signals from/to the respective peripherals, wherein said user end unit and said mainframe end unit are separately implemented in different individual objects, and connected with each other by means of a connection medium so that the signals are transferred therebetween.

According to another aspect of the present invention, the connection medium is implemented by optical fiber.

According to a further aspect of the present invention, each of the user end unit and the mainframe end unit has an encoder/decoder and an I/O device.

According to still another aspect of the present invention, wherein the user end unit is integrated in a monitor, while the mainframe end unit is integrated in the mainframe of the computer.

### BRIEF DESCRIPTION OF THE DRAWINGS

The following drawings are only for illustrating the mutual relationships between the respective portions and are not drawn according to practical dimensions and ratios. In addition, the like reference numbers indicate the similar elements.

FIG. 1 schematically illustrates an implementation of the present invention;

FIG. 2 shows an exemplary embodiment of the present invention; and

FIG. 3 schematically illustrates an exemplary application of the present invention.

### DETIALED DESCRIPTION OF THE PREFERRED EMBODIMENT

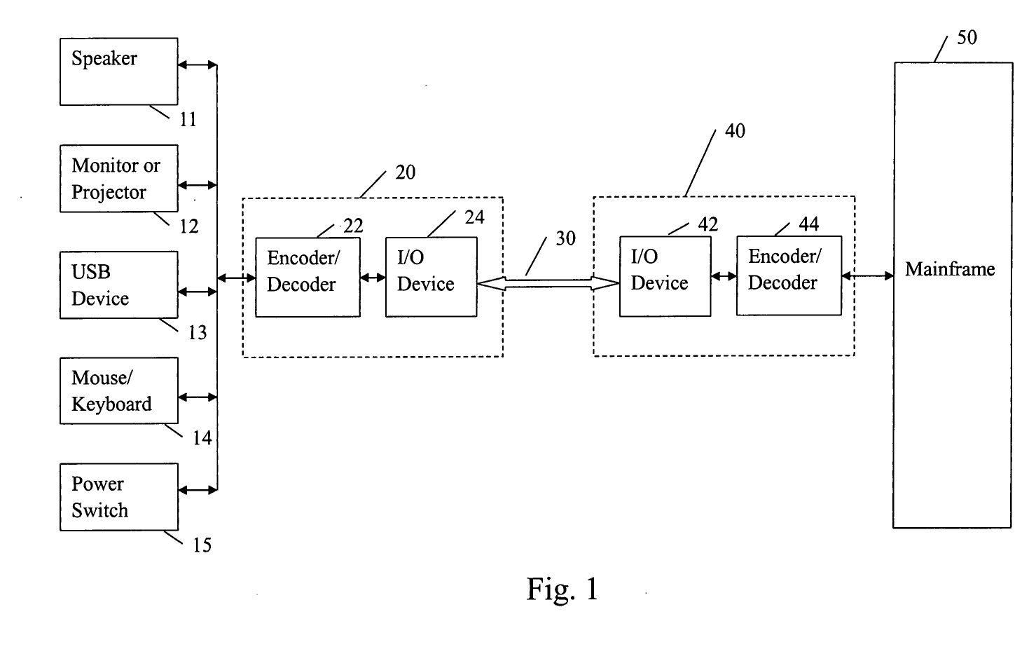

With reference to FIG. 1, a computer peripheral interface according to the present invention comprises a user end unit 20, connection medium 30 and mainframe end unit 40. Various peripherals such as audio speaker 11, monitor (or projector) 12, USB device 13, mouse/keyboard 14 and power switch 15 are connected by cable or wireless interconnections, for example, to the user end unit 20. The user end unit 20 can be implemented as a separate module and disposed at a location near the user. Preferably, the connection medium 30 connecting the user end unit 20 with the mainframe end unit 40 is implemented by optical fibers. However, any other suitable connection medium can also be used. The mainframe end unit 40 is connected with a mainframe 50 by a cable or wireless interconnections, for example.

The user end unit 20 comprises an encoder (e.g. multiplexer or serializer)/decoder (e.g. demultiplexer or deserializer) 22 and I/O device 24, which comprises a fiber transceiver, fiber module, or transmitter with light source/receiver with photodiode. In an operation that data is transferred from the peripherals 11-15 to the mainframe 50, the user end unit 20 receives signals from the various peripherals 11-15, encodes (multiplexes by WDM (wavelength division multiplexing) or TDM (time division multiplexing, for example, or serializes) the signals with the encoder/decoder 24, and transmits the processed signals through the I/O device 24 to the mainframe end unit 40 via the optical fiber 30. The mainframe end unit 40 also has an I/O device 42, which comprises a fiber transceiver, fiber module, or transmitter with light source/receiver with photodiode, and an encoder (e.g. multiplexer or serializer)/decoder (e.g. demultiplexer or deserializer) 44 for receiving the signals and decoding (demultiplexing or deserializing) the same, respectively. In an operation that data is transferred from the mainframe 50 to the peripherals 11-15, the mainframe end unit 40 receive signals from the mainframe 50, encodes (multiplexes by WDW or TDM, for example, or serializes) the signals with the encoder/decoder 44, and transmits the processed signals through the I/O device 42 to the user end unit 20 via the optical fiber 30. The user end unit 20 receives the signals by the I/O device 24, decodes (demultiplexes or deserializes) the signals with the encoder/decoder (e.g. demultiplexer or deserializer) 22 and passes the processed signals to the peripherals.

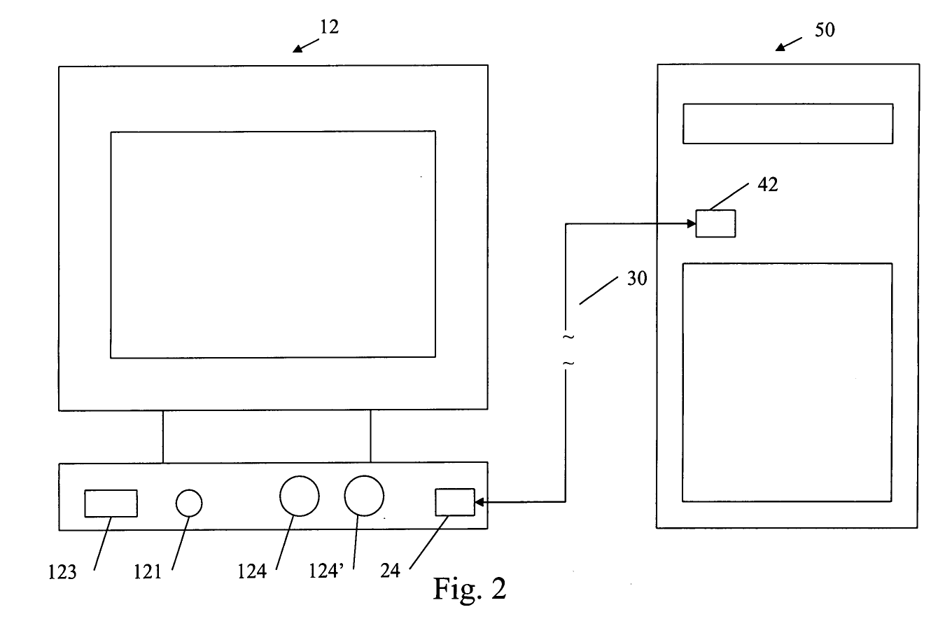

In a preferred embodiment, the user end unit 20 is integrated into the monitor (or projector) 12, and the mainframe end unit 40 is built in the mainframe 50. As shown in FIG. 2, the connection ports such as audio output port 121, USB port 123, keyboard and mouse connection ports 124 and 124′ are disposed in a base of the monitor 12. Then the user end unit built in the monitor 12 is connected to the mainframe by the optical fiber 30 connecting the I/O device (e.g. transceiver) 24 of the user end unit 20 and the I/O device (e.g. transceiver) 42 of the mainframe end unit 40. The user end unit 20 can also be integrated in any other suitable peripheral.

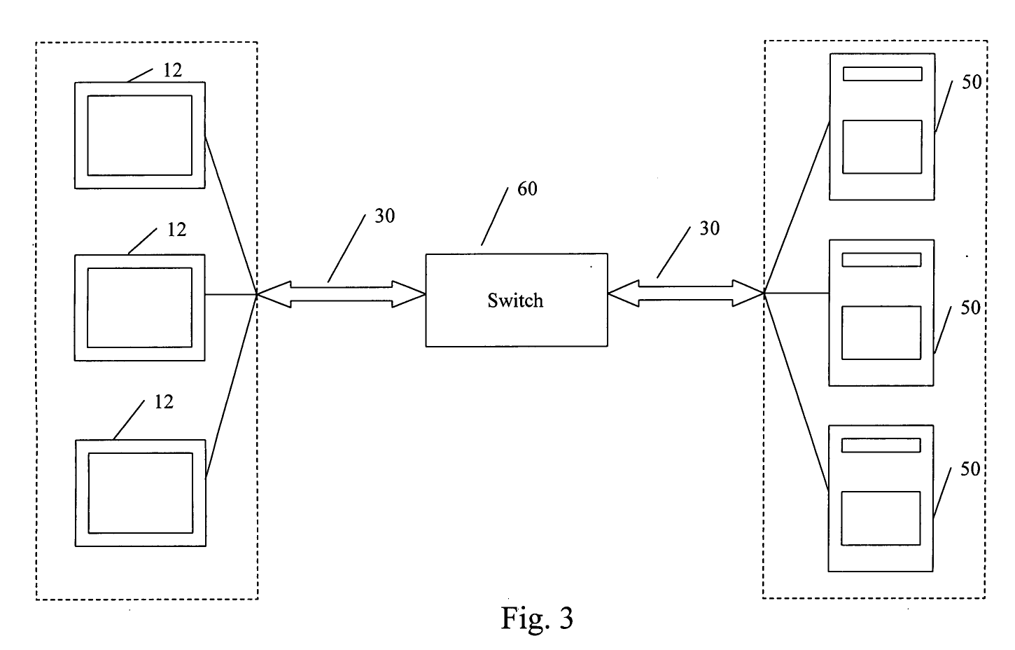

The communication quality of optical fiber is highly reliable, and optical fiber is suitable to be used in long distance connection. In application, for example, a number of monitors (or projectors) 12, each of which is integrated with the user end unit 20 of the computer peripheral interface in accordance with the present invention, can be placed in a room or in different rooms. Other peripherals such as mouse, keyboard, print, camera, USB device, IEEE 1394 device, audio speaker, microphone, telephone, touch panel, joystick, wireless controller, power switch and the like are all connected to the user end unit 20 integrated in the monitor 12. The monitors 12 are connected to the respective mainframes 50 via optical fibers, for example. The mainframes 50 can be concentrically placed in the same room for the sake of convenience of management, as shown in FIG. 3. A fiber switch 60 can be provided to control the switching of the connections.

While the embodiment of the present invention is illustrated and described, various modifications and alterations can be made by persons skilled in this art. The embodiment of the present invention is therefore described in an illustrative but not restrictive sense. It is intended that the present invention may not be limited to the particular forms as illustrated, and that all modifications and alterations which maintain the spirit and realm of the present invention are within the scope as defined in the appended claims.

What is claimed is:

1. A computer peripheral interface comprising:
a mainframe end unit for connection with a mainframe of the computer and for receiving/transmitting signals from/to the mainframe; and
a user end unit for connection with a plurality of peripherals and for receiving/transmitting signals from/to the respective peripherals,
wherein said user end unit and said mainframe end unit are separately implemented in different individual objects, and connected with each other by means of a connection medium so that the signals are transferred therebetween.

2. The computer peripheral interface as claimed in claim 1, wherein the user end unit has an encoder/decoder for encoding the signals after the user end unit receives the signals from the peripherals, and decoding the signals before the user end unit transmits the signals to the peripherals.

3. The computer peripheral interface as claimed in claim 2, wherein the encoder/decoder is a multiplexer/demultiplexer.

4. The computer peripheral interface as claimed in claim 3, wherein the multiplexer/demultiplexer utilizes WDM (wavelength division multiplexing).

5. The computer peripheral interface as claimed in claim 3, wherein the multiplexer/demultiplexer utilizes TDM (time division multiplexing).

6. The computer peripheral interface as claimed in claim 2, wherein the encoder/decoder is a serializer/deserializer.

7. The computer peripheral interface as claimed in claim 1, wherein the user end unit has a combined I/O device for receiving/transmitting signals.

8. The computer peripheral interface as claimed in claim 7, wherein the connection medium is implemented by optical fiber, and the I/O device is selected from the group of fiber transceiver, fiber module, and transmitter with light source/receiver with photodiode.

9. The computer peripheral interface as claimed in claim 1, wherein the mainframe end unit has an encoder/decoder for encoding the signals after the mainframe end unit receives the signals from the mainframe, and decoding the signals before the mainframe end unit transmits the signals to the mainframe.

10. The computer peripheral interface as claimed in claim 9, wherein the encoder/decoder is a multiplexer/demultiplexer.

11. The computer peripheral interface as claimed in claim 10, wherein the multiplexer/demultiplexer utilizes WDM (wavelength division multiplexing).

12. The computer peripheral interface as claimed in claim 10, wherein the multiplexer/demultiplexer utilizes TDM (time division multiplexing).

13. The computer peripheral interface as claimed in claim 9, wherein the encoder/decoder is a serializer/deserializer.

14. The computer peripheral interface as claimed in claim 1, wherein the mainframe end unit has an I/O device for receiving/transmitting signals.

15. The computer peripheral interface as claimed in claim 14, wherein the connection medium is implemented by optical fiber, and the I/O device is selected from the group of fiber transceiver, fiber module, and transmitter with light source/receiver with photodiode.

16. The computer peripheral interface as claimed in claim 1, wherein the connection medium is implemented by optical fiber.

17. The computer peripheral interface as claimed in claim 1, wherein the user end unit is integrated in one of the peripherals.

18. The computer peripheral interface as claimed in claim 1, wherein the peripherals are selected from a group of a monitor, projector, mouse, keyboard, cameral, USB device, IEEE 1394 device, speaker, microphone, printer, touch panel, joystick, telephone, wireless controller, and power switch.

19. The computer peripheral interface as claimed in claim 1, wherein the mainframe end unit is integrated in the mainframe.

20. The computer peripheral interface as claimed in claim 1, wherein the mainframe end unit and the user end unit are implemented as individual modules or interface cards, respectively.
